(19) United States
(12) Patent Application Publication
(10) Pub. No.: US 2025/0367652 A1
(43) Pub. Date: Dec. 4, 2025

(54) REGENERATION OF METHANE OXIDATION CATALYSTS

(71) Applicants: Johnson Matthey Inc, Harrisburg, PA (US); UT-Battelle, LLC, Oak Ridge, TN (US)

(72) Inventors: Haiying CHEN, Oak Ridge, TN (US); Joseph FEDEYKO, Wayne, PA (US); Yuliana LUGO-JOSE, Wayne, PA (US)

(21) Appl. No.: 19/093,540

(22) Filed: Mar. 28, 2025

Related U.S. Application Data
(60) Provisional application No. 63/652,373, filed on May 28, 2024.

(51) Int. Cl. B01J 38/12; B01D 53/86; B01D 53/96; B01J 21/04; B01J 23/44; B01J 23/96; B01J 38/02; B01J 38/06

(52) U.S. Cl. CPC B01J 38/12; B01D 53/864; B01D 53/96; B01J 21/04; B01J 23/44; B01J 23/96; B01J 38/02; B01J 38/06; B01D 2257/7025; B01D 2258/018; B01D 2258/0266; B01D 2258/0283

(57) ABSTRACT

Disclosed are methods for regenerating an at least partially deactivated methane oxidation catalyst comprising contacting the catalyst with a gas stream comprising carbon monoxide (CO) under conditions that are net lean of stoichiometry and at a temperature of about 125° C. to about 450° C. over a period of time. Also provided are methane oxidation catalysts that have been regenerated according to the disclosed methods, as well as methods of catalyzing methane oxidation.

### CROSS-REFERENCE TO RELATED APPLICATIONS

This application claims the benefit of priority to U.S. Provisional Application No. 63/652,373, filed May 28, 2024, the entire contents of which are incorporated herein by reference.

### GOVERNMENT RIGHTS

This invention was made with government support under DE-AR0001532 awarded by United States Department of Energy, Office of ARPA-E, and under DE-AC05-00OR22725, awarded by the United States Department of Energy. The government has certain rights in the invention.

### TECHNICAL FIELD

The present disclosure pertains to regeneration of deactivated catalysts for the oxidation of methane.

### BACKGROUND

Catalytic oxidation of methane is of great importance either for methane combustion as an energy source or for methane abatement from various exhaust streams, such as CNG engine exhausts, coal mine ventilation air, flare gas, and agricultural sources. Complete oxidation of methane to CO₂ effectively reduces its environmental impact by more than 96% as the global warming potential of methane is about 28-36 times greater than that of CO₂ over a 100-year scale. Chen, et al., Applied Catalysis A, General 633 (2022) 118534.

Pd/γ-Al₂O₃ catalysts are one of the most active components in catalyzing methane oxidation. However, under reaction conditions, especially in a wet feed, these and other methane oxidation catalysts can suffer from gradual deactivation. Periodic exposure of these catalysts to conditions that are net rich of stoichiometry (λ≤˜1) has been reported to provide a degree of regeneration, although this method is not generally useful because generating a net reducing atmosphere is not practical for most applications involving net lean methane oxidation.

### SUMMARY

Provided herein are methods for regenerating an at least partially deactivated methane oxidation catalyst comprising contacting the catalyst with a gas stream comprising carbon monoxide (CO) under conditions that are net lean of stoichiometry and at a temperature of about 125° C. to about 450° C. over a period of time.

Also provided are methane oxidation catalysts that have been at least partially regenerated according to the presently disclosed methods.

The present disclosure also provides methods of catalyzing methane oxidation comprising exposing a methane oxidation catalyst to a source of methane until the catalyst is at least partially deactivated; and, contacting the at least partially deactivated catalyst with a gas stream comprising carbon monoxide (CO) under conditions that are net lean of stoichiometry and at a temperature of about 125° C. to about 450° C. over a period of time until the catalyst is at least partially regenerated.

### DETAILED DESCRIPTION OF ILLUSTRATIVE EMBODIMENTS

The present invention may be understood more readily by reference to the following detailed description taken in connection with the accompanying examples, which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of the claimed invention.

The disclosures of each patent, patent application, and publication cited or described in this document are hereby incorporated herein by reference, in their entirety.

As employed above and throughout the disclosure, the following terms and abbreviations, unless otherwise indicated, shall be understood to have the following meanings.

In the present disclosure the singular forms “a”, “an”, and “the” include the plural reference, and reference to a particular numerical value includes at least that particular value, unless the context clearly indicates otherwise. Thus, for example, a reference to “a compound” is a reference to one or more of such compounds and equivalents thereof known to those skilled in the art, and so forth. Furthermore, when indicating that a certain chemical moiety “may be” X, Y, or Z, it is not necessarily intended by such usage to exclude other choices for the moiety; for example, a statement to the effect that a moiety “may be alkyl, aryl, or amino” does not necessarily exclude other choices for the moiety, such as halo, aralkyl, and the like. [0012] When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” may refer to a value of 7.2 to 8.8, inclusive; as another example, the phrase “about 8%” may refer to a value of 7.2% to 8.8%, inclusive. Also, when the term “about” precedes a range, it is understood that the term modifies both recited endpoints and all points embraced within the range. For example, the phrase “about 1-10” is understood to mean “about 1 to about 10”, as well as “about x”, wherein x refers to any value between 1 and 10. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” In another example, when a listing of possible choices for a moiety including “hydrogen, alkyl, and aryl” is provided, the recited listing may be construed as including situations whereby any of hydrogen, alkyl, and aryl is negatively excluded; thus, a recitation of “hydrogen, alkyl, and aryl” may be construed as “hydrogen and aryl, but not alkyl”, or simply “wherein the moiety is not alkyl”.

As noted, methane oxidation catalysts can suffer from gradual deactivation. The present inventors have surprisingly discovered that exposure of deactivated methane oxidation catalysts to carbon monoxide under net lean conditions can regenerate catalytic activity. The present methods and the regenerated catalysts that can be created thereby are applicable to any system for methane oxidation, including those in which the source of methane comprises exhaust from a natural gas-fired engine, ventilation air methane from a mining operation, flare gas, or an agricultural source.

Accordingly provided herein are methods for regenerating an at least partially deactivated methane oxidation catalyst comprising contacting the catalyst with a gas stream comprising carbon monoxide (CO) under conditions that are net lean of stoichiometry and at a temperature of about 125° C. to about 450° C. over a period of time.

As used herein, “an at least partially deactivated” catalyst is one having a methane conversion efficiency that has been diminished as a result of its use for the catalysis of methane oxidation, relative to its methane conversion efficiency (“initial conversion efficiency”) prior to its use for the catalysis of methane oxidation. For example, a methane oxidation catalyst that has an initial conversion efficiency of 85%, is then used for methane oxidation, and subsequently has a conversion efficiency of less than 85% can be said to be at least partially deactivated. In some embodiments, the decrease in conversion efficiency from the initial efficiency to the state of being at least partially deactivated may be about 5-50%, such as about 5, 10, 15, 20, 25, 30, 35, 40, 45, or 50%. The present methods are useful for improving the conversion efficiency of a methane oxidation catalyst that has been deactivated to any degree. Pursuant to the present methods, the at least partially deactivated catalyst may have a conversion efficiency of less than about 80% prior to contacting the catalyst with the gas stream comprising carbon monoxide. For example, the at least partially deactivated catalyst may have a conversion efficiency of about 10-79%, such as a conversion efficiency of about 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, or 78% prior to contacting the catalyst with the gas stream comprising carbon monoxide.

Conditions that are “net lean of stoichiometry” refer to those in which lambda (2) is greater than 1.

In certain embodiments, the methane oxidation catalyst is a platinum group metal (PGM) catalyst, i.e., comprises a PGM metal. For example, the catalyst may be a palladium- or platinum-containing catalyst. In such embodiments, the platinum group metal may be supported or unsupported. The PGM catalyst may be supported on an inorganic oxide material, such as an oxide of elements 2, 3, 4, 5, 13 and 14. Most preferably, the first support may be alumina, silica, titania, zirconia, magnesia, ceria, niobia, tantalum oxide, molybdenum oxide, tungsten oxide, zeolite, mixed oxides of any two or more thereof, complex oxides of any two or more thereof, or any combination of the preceding. Useful inorganic oxides preferably have a surface area in the range of 10 to 1500 m²/g, a pore volume in the range of 0.1 to 4 mL/g, and a pore diameter of about 10 to 1000 angstroms. Preferably, the support material is alumina.

The period of time during which the catalyst is contacted with the gas stream comprising carbon monoxide can have a duration of about 10 minutes to about 2 hours, such about 15 minutes to about 2 hours, about 20 minutes to about 2 hours, about 30 minutes to about 2 hours, about 45 minutes to about 2 hours, about 1 to about 2 hours, or about 1.5 hours to about 2 hours, such as about 10, 15, 20, 25, 30, 35, 40, 45, 50, 60, 65, 70, 75, 80, 85, 90, 95, 100, 105, 110, 115, or 120 minutes.

The catalyst may comprise a substrate and a catalytic layer deposited on the substrate. The substrate may be, for example, a honeycomb monolith substrate. The catalyst that includes the substrate and the catalytic layer deposited thereon may have an inlet end, and outlet end, and middle portion extending therebetween along an axis. Thus, catalyst can assume a configuration such that there is a portion of a catalyst that is proximal with respect to an inlet end of a container housing the catalyst and through which a methane feed stream enters, and a portion of the catalyst that is distal with respect to the inlet end and proximal with respect to an outlet end of the container housing the catalyst through which the feed stream exits after traversing the length of the container and of the catalyst. In certain embodiments, the catalysts in accordance with the present methods can comprise an inlet end and an outlet end, and the CO contacts the inlet end of the catalyst and the outlet end of the catalyst during the period of time. Stated differently, during at least a portion of the period of time, the CO in the gas stream that first contacts the inlet end of the catalyst is not completely consumed before at least a portion of the CO contacts the outlet end of the catalyst. In certain embodiments, the catalysts comprise a volume of material, and during the period of time the CO contacts the entire catalyst volume, i.e., there is at least one point during the period of time when any given portion of the catalyst is contacted with the CO, such that there are no portions of the catalyst that the CO does not contact.

In the present methods, the catalyst is contacted with the CO at a temperature of about 125° C. to about 450° C. during the period of time. The temperature may be held constant over the period of time, e.g., the temperature may be held at about 150° C. during the period of time. The constant temperature at which the catalyst is contacted with the CO may be, for example, about 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, or 450° C. In other embodiments, the temperature is varied over the period of time. For example, the temperature may be decreased over the period of time, such that the temperature at the beginning of the period of time is greater than the temperature at a later point during the period of time. Alternatively, the temperature may be increased over the period of time, such that the temperature at the beginning of the period of time is less than the temperature at a later point during the period of time. In other embodiments, the temperature is varied by one or more increases over the period of time and one or more decreases over the period of time.

The catalyst may be contacted with the gas stream at a temperature of about 250° C. to about 450° C. at the beginning of the period of time and is reduced to about 125° C. to about 200° C. by the end of the period of time. Alternatively, the catalyst may be contacted with the gas stream at a temperature of about 350° C. to about 450° C. at the beginning of the period of time and is reduced to about 125° C. to about 200° C. by the end of the period of time. In other embodiments, the catalyst may be contacted with the gas stream at a temperature of about 350° C. to about 450° C. at the beginning of the period of time and is reduced to about 125° C. to about 200° C. by the end of the period of time. In other instances, the catalyst is contacted with the gas stream at a temperature of about 425° C. to about 450° C. at the beginning of the period of time and is reduced to about 125° C. to about 200° C. by the end of the period of time. In other embodiments, the catalyst is contacted with the gas stream at a temperature of about 125° C. to about 200° C. at the beginning of the period of time and is increased to about 250° C. to about 450° C. by the end of the period of time. The catalyst may alternatively be contacted with the gas stream at a temperature of about 125° C. to about 200° C. at the beginning of the period of time and is increased to about 350° C. to about 450° C. by the end of the period of time.

The gas stream with which the catalyst is contacted during the period of time may have a CO concentration of about 100-50,000 ppm. For example, the gas stream may have a CO concentration of about 200-30,000, 300-25,000, 400-20,000, 400-15,000, 500-10,000, 500-7,500, 600-5,000, 700-2,500, 800-2,000, 900-1,500, or 900-1,200 ppm, or may have a CO concentration of about 200, 300, 400, 500, 600, 700, 800, 900, 1000, 1200, 1300, 1400, 1500, 1600, 1700, 1800, 1900, 2000, 2100, 2200, 2300, 2400, 2500, 2600, 2700, 2800, 2900, 3000, 3500, 4000, 4500, 5000, 5500, 6000, 6500, 7000, 7500, 8000, 8500, 9000, 9500, 10,000, 12,000, 14,000, 16,000, 18,000, 20,000, 22,000, 24,000, 26,000, 28,000, 30,000, 32,000, 34,000, 36,000, 38,000, 40,000, 42,000, 44,000, 46,000, 48,000, or 50,000 ppm.

The gas stream comprising CO may also contain oxygen (O₂). For example, the gas stream may comprise O₂ in a concentration of about 1-25%, such as about 1, 2, 3, 4, 5, 6, 7, 8, 9, 10, 11, 12, 13, 14, 15, 16, 17, 18, 19, 20, 21, 22, 23, 24, or 25%.

The gas stream comprising CO may also contain water (H₂O). For example, the gas stream may comprise H₂O in a concentration of up to about 10% such as about 1, 2, 3, 4, 5, 6, 7, 8, 9, or 10%.

Also provided are methane oxidation catalysts that have been at least partially regenerated according to any embodiment of the presently disclosed methods. Such regenerated catalysts feature a methane conversion efficiency that renders the catalyst useful for catalyzing methane oxidation in any system for methane oxidation, including those in which the source of methane comprises exhaust from a natural gas-fired engine, ventilation air methane from a mining operation, flare gas, or an agricultural source.

An “at least partially regenerated” catalyst is one having a conversion efficiency that is higher than the conversion efficiency of the same catalyst in the at least partially deactivated state, i.e., prior to the step of contacting the catalyst with a gas stream comprising CO under conditions that are net lean of stoichiometry and at a temperature of about 125° C. to about 450° C. over the period of time. The conversion efficiency of an at least partially regenerated catalyst according to the present disclosure may be about 5-100% higher than the conversion efficiency of the same catalyst in the at least partially deactivated state. For example, the conversion efficiency of the at least partially regenerated catalyst may be about 5, 10, 15, 20, 25, 30, 35, 40, 45, 50, 55, 60, 65, 70, 75, 80, 85, 90, 95, or 100% higher than the conversion efficiency of the same catalyst in the at least partially deactivated state.

Following the period of time during which the catalyst is exposed to the gas stream comprising CO, the methane conversion efficiency of an at least partially regenerated methane oxidation catalyst according to the present disclosure may be about 50-100%, such as about 50, 55, 60, 65, 70, 75, 80, 95, 90, 95, 99, or 100%.

The catalyst may be of any type disclosed supra in connection with the present methods of regenerating a methane oxidation catalyst. For example, the methane oxidation catalyst may be a platinum group metal (PGM) catalyst.

The present disclosure also provides methods of catalyzing methane oxidation comprising exposing a methane oxidation catalyst to a source of methane until the catalyst is at least partially deactivated; and, contacting the at least partially deactivated catalyst with a gas stream comprising carbon monoxide (CO) under conditions that are net lean of stoichiometry and at a temperature of about 125° C. to about 450° C. over a period of time until the catalyst is at least partially regenerated.

The exposure of the methane oxidation catalyst to a source of methane may be performed by exposing the catalyst to exhaust containing methane, such as exhaust from a natural gas-fired engine, ventilation air methane from a mining operation, flare gas, or an agricultural source. Systems for the catalysis of methane oxidation are well known among those skilled in the art, and any of such systems may be used in order to perform the step of exposing the methane oxidation catalyst to a source of methane.

The exposure of the methane oxidation catalyst to a source of methane occurs until the catalyst is at least partially deactivated, which is defined as specified supra. The time of exposure to the source of methane in order to result in deactivation of the catalyst will vary depending on the characteristics of the catalyst, the system in which the catalyst operates, and the properties of the source of methane. The criteria for deciding whether the methane oxidation catalyst is deactivated to an extent such as to require regeneration may be determined using standards that are well understood among those skilled in the art. In some instances, the methane oxidation catalyst may be exposed to the source of methane until it displays a decrease in conversion efficiency relative to the initial efficiency by about 5-50%, such as about 5, 10, 15, 20, 25, 30, 35, 40, 45, or 50%.

The step of contacting the at least partially deactivated catalyst with a gas stream comprising carbon monoxide (CO) may be performed in accordance with any of the embodiments previously described pursuant to the inventive methods of regenerating an at least partially deactivated methane oxidation catalyst. The particular approach for contacting the at least partially deactivated catalyst with a gas stream comprising CO can include replacing the source of methane with the gas stream comprising CO. In such instances, the source of methane is cut off or diverted from the catalyst, and then the catalyst is exposed to the gas stream comprising CO. In other embodiments, the source of methane is not cut off or diverted from the catalyst, and the gas stream comprising CO is added to the methane feed representing the source of methane. Accordingly, the catalyst can be simultaneously exposed to the source of methane and the CO.

The step of exposing the at least partially deactivated methane oxidation catalyst to the gas stream comprising CO at least partially regenerates the methane oxidation catalyst, wherein at least partial regeneration is defined as specified supra. In some embodiments, the at least partially deactivated catalyst has a conversion efficiency of less than about 20-80%, and the catalyst has a higher conversion efficiency, for example, of about 35% to 100%, following the period of time, i.e., the at least partially regenerated catalyst has a conversion efficiency of about 35% to 100%.

The present methods of catalyzing methane oxidation may comprise a further step of re-exposing the at least partially regenerated catalyst to the source of methane following the period of time in order to catalyze oxidation of the methane. In other words, the present methods may include using the catalyst for the catalysis of methane after the catalyst has been at least partially regenerated.

### EXAMPLES

The present invention is further defined in the following Examples. It should be understood that these examples, while indicating preferred embodiments of the invention, are given by way of illustration only, and should not be construed as limiting the appended claims. From the above discussion and these examples, one skilled in the art can ascertain the essential characteristics of this invention, and without departing from the spirit and scope thereof, can make various changes and modifications of the invention to adapt it to various usages and conditions.

### Example 1—Regeneration of Deactivated PdO/γ-Al₂O₃Catalyst

At 450° C., a 700° C./16 h hydrothermally aged PdO/γ-Al₂O₃ catalyst achieves 40% CH₄ conversion. After exposing to wet CH₄ oxidation for 14 h at this temperature, the CH₄ conversion decreases to 17%. Table 1, below, illustrates the effectiveness of running CO oxidation to regenerate the deactivated PdO/γ-Al₂O₃ catalyst (17% conversion efficiency) for lean methane oxidation. The table shows the CH₄ breakthrough of the pristine catalyst, i.e., prior to use for methane oxidation (pristine), and of the deactivated catalyst following different regeneration procedures.

TABLE 1

| Condition | CH₄ Breakthrough (ppm)^{a} |
|---|---|
| Pristine | 599 |
| Wet CH₄ oxidation at 450° C. for 14 h | 832 |
| CO + O₂ + H₂O at 450° C. for 1 h^{b} | 739 |
| CO + O₂ + H₂O ramp down from 450° C. to | 518 |
| 150° C. over 1 h^{b} | |
| CO + O₂ + H₂O at 150° C. for 1 h^{b} | 630 |

^{a}Outlet CH₄ concentration after 5 min into wet CH₄ oxidation reaction at 450° C. (1000 ppm CH₄ + 18% O₂ + 3% H₂O + Ar)
^{b}1000 ppm CO + 18% O₂ + 3% H₂O + Ar at flow rate of 1.25 L/min

As shown above, exposing the deactivated catalyst to lean CO oxidation (1000 ppm CO+18% O₂+3% H₂O+Ar) at 450° C. for 1 h regenerated the methane oxidation activity, with the conversion efficiency increasing from 17% to 26%. In a separate experiment, exposing the deactivated catalyst to lean CO oxidation (1000 ppm CO+18% O₂+3% H₂O+Ar) at 150° C. for 1 h recovered the methane oxidation activity better, with the conversion efficiency increased from 17% to 37%. In a third experiment, exposing the deactivated catalyst to lean CO oxidation (1000 ppm CO+18% O₂+3% H₂O+Ar) at 450-150° C. by ramping the temperature down recovered the methane oxidation activity even better, whereby the conversion efficiency increased from 17% to 48%. In fact, the conditions of the third experiment activated the catalyst, conferring a higher CH₄ conversion efficiency than the pristine catalyst.

What is claimed:

1. A method for regenerating an at least partially deactivated methane oxidation catalyst comprising contacting the catalyst with a gas stream comprising carbon monoxide (CO) under conditions that are net lean of stoichiometry and at a temperature of about 125° C. to about 450° C. over a period of time.

2. The method according to claim 1, wherein the catalyst comprises a platinum group metal (PGM) catalyst.

3. The method according to claim 2, wherein the catalyst comprises a PGM supported on a support material comprising alumina, silica, titania, zirconia, magnesia, ceria, niobia, tantalum oxide, molybdenum oxide, tungsten oxide, zeolite, mixed oxides or complex oxides of any two or more thereof, or any combination thereof.

4. The method according to claim 1, wherein the catalyst has a methane conversion efficiency of less than about 25% prior to contacting the catalyst with the gas stream.

5. The method according to claim 1, wherein the period of time of contacting the catalyst with the gas stream has a duration of about 15 minutes to about 2 hours.

6. The method according to claim 1, wherein catalyst comprises an inlet end and an outlet end, and the CO contacts the inlet end of the catalyst and the outlet end of the catalyst during the period of time.

7. The method according to claim 1, wherein the temperature is held constant over the period of time.

8. The method according to claim 1, wherein the temperature is varied over the period of time.

9. The method according to claim 1, wherein the catalyst is contacted with the gas stream at a temperature of about 250° C. to about 450° C. at the beginning of the period of time and is reduced to about 125° C. to about 200° C. by the end of the period of time.

10. The method according to claim 1, wherein the catalyst is contacted with the gas stream at a temperature of about 125° C. to about 200° C. at the beginning of the period of time and is increased to about 250° C. to about 450° C. by the end of the period of time.

11. The method according to claim 1, wherein the gas stream comprises a CO concentration of about 100 ppm to 50,000 ppm.

12. The method according to claim 1, wherein the gas stream comprises O₂ at a concentration of about 1-25%.

13. The method according to claim 1, wherein the gas stream comprises H₂O in a concentration of about 0-10%.

14. A methane oxidation catalyst that has been at least partially regenerated according to the method of claim 1.

15. A method of catalyzing methane oxidation comprising:
exposing a methane oxidation catalyst to a source of methane until the catalyst is at least partially deactivated; and,
contacting the at least partially deactivated catalyst with a gas stream comprising carbon monoxide (CO) under conditions that are net lean of stoichiometry and at a temperature of about 125° C. to about 450° C. over a period of time until the catalyst is at least partially regenerated.

16. The method according to claim 15 wherein the at least partially deactivated catalyst is contacted with the gas stream by replacing the source of methane with the gas stream comprising CO.

17. The method according to claim 15 wherein the at least partially deactivated catalyst is contacted with the gas stream by adding CO to a methane feed representing the source of methane.

18. The method according to claim 15, wherein the at least partially deactivated catalyst has a conversion efficiency of less than about 20%, and the catalyst has a conversion efficiency of about 30% to 50% following the period of time.

19. The method according to claim 15, further comprising re-exposing the at least partially regenerated catalyst to the source of methane following the period of time in order to catalyze oxidation of the methane.

20. The method according to claim 15, wherein the source of methane comprises exhaust from a natural gas-fired engine, ventilation air methane from a mining operation, flare gas, or an agricultural source.
